(19) United States
(12) Patent Application Publication
(10) Pub. No.: US 2005/0098684 A1
(43) Pub. Date: May 12, 2005

(54) Polymer-encapsulated heating elements for controlling the temperature of an aircraft compartment

(75) Inventors: Steven Gullerud, La Crosse, WI (US); Dane Hofmeister, Winona, MN (US); Greg Marmsoler, Winona, MN (US); Mark Silva, Alta Loma, CA (US)

Correspondence Address: HARNESS, DICKEY, & PIERCE, P.L.C, 7700 BONHOMME, STE 400, ST. LOUIS, MO, 63105, US

(73) Assignee: Watlow Polymer Technologies, Winona, MN (US)

(21) Appl. No.: 10/389,399

(22) Filed: Mar. 14, 2003

(51) Int. Cl. B64C 1/00

(52) U.S. Cl. 244/129.1

(57) ABSTRACT

The invention relates to polymer-encapsulated heating elements that are suitable for use in an aircraft compartment for modulating the temperature within the compartment. The heating elements can be used, for example, in the cockpit, the passenger compartment, or a cargo bay of an aircraft.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM LISTING APPENDIX SUBMITTED ON A COMPACT DISC

Not Applicable.

### BACKGROUND OF THE INVENTION

The invention relates generally to the field of aviation, and more particularly to the control of aircraft compartment temperature.

Aircraft often operate in low temperature environments, such as at high altitudes and in cold climates. As a result, the temperature of air within compartments of aircraft can drop below temperatures considered comfortable by crew and passengers. Inadequate compartment temperatures can also adversely affect cargo carried by aircraft or operation of aircraft systems or components located in the compartment. Control of aircraft compartment temperature is important for at least these reasons.

Various means have been used to modulate the temperature of crew, passenger, and cargo cabins of aircraft. Use of active heating systems is common. One common heating system uses a heat exchanger to transfer heat from an exhaust stream of the an aircraft propulsion system (e.g., combustion exhaust from a propeller-driving engine or compressor bleed air from a jet engine) to an air stream (one or both of ambient air and recycled cabin air) that is fed to the cabin. Another common heating system mixes hot compressor bleed air with recycled cabin air and provides the warm, mixed air to the cabin. A drawback of these systems is that pollutants can be present in the propulsion exhaust stream, the ambient air, or both, and must be either removed or tolerated. Another drawback of heating systems that draw bleed air from the compressor is that the fuel efficiency of the engine is decreased.

Other aircraft compartment heaters transfer heat from a high-temperature electrical heating element or from a fuel combustion chamber to an air stream that is fed to the cabin. Because aircraft carry flammable fuel and operate in environments in which access to emergency services can be severely restricted, the presence of combustion units and high-temperature heating elements on aircraft is undesirable.

Many aircraft compartments are insulated to reduce or prevent heat loss therefrom. Use of fiberglass, foam, and other types of insulation is known. Although insulation can reduce heat loss from an aircraft compartment, such insulation can add significant weight to an aircraft, can be difficult to maintain, and can pose hazards to passengers, crew members, and others in the event of a fire or other emergency. Other methods of controlling heat loss from an aircraft compartment would be useful.

The heat exchangers, heating blocks, combustion chambers, ductwork, and other equipment associated with traditional aircraft heaters increase the weight of the aircraft, as does insulation. As a result the fuel efficiency of the aircraft is lower than it would be in the absence of the heating system. Because fuel consumption represents a major cost of aircraft operation, aircraft heating systems lighter than those presently available could significantly reduce aircraft operating expenses.

Most aircraft compartment heating systems combine the functions of heating compartment air and ventilating the compartment. The compartment is heated by forcing heated air through the compartment. Because of the temperature of heated air that can be safely and comfortably passed into the compartment, heating a cold aircraft can require relatively high heated air flow velocities, which can be uncomfortable or unattainable. An aircraft compartment heater that is able to provide heat relatively rapidly without a concomitant increase in compartment air flow would be desirable.

The present invention provides aircraft compartment heating that meets the needs described above.

### BRIEF SUMMARY OF THE INVENTION

The invention relates to a method of controlling the temperature within an aircraft compartment. The method comprises activating a heating element in the compartment. The heating element comprises an electrical resistance heating material encapsulated in a substantially non-compressible polymer. The heating element can be activated when the temperature within the compartment is below a selected minimum temperature and/or not greater than a selected maximum temperature. Alternatively, the heating element can simply be activated periodically (e.g. manually, using a timer, or using a thermostat) while the aircraft is in flight.

The heating material of the heating element can be activated by connecting it with a voltage source by way of a pair of electrical terminals extending through the polymer. The electrical terminals can be connected with a voltage source by way of wires. The terminals, the portion of the wires proximal to the heating element, or both, can be encapsulated within the same polymer or a second polymer. The voltage source can, for example, be an electrical system of the aircraft or an airport electrical system.

In one embodiment, the electrical circuit that comprises the heating element further comprises a temperature sensing device. The temperature sensing device can be used to monitor the temperature of the heating element, the temperature within the compartment, or both. For example, the temperature sensing device can be a fusible link that melts (and thereby breaks all or part of the circuit) when the fusible link reaches a selected temperature. Similarly, the temperature sensing device can be a thermostat or some other device that deactivates the heating element if the temperature of the polymer exceeds a selected temperature. Devices that modulate the voltage provided to the heating element in response to the temperature of the element, the compartment, or both, can also be used.

The polymer in which the electrical resistance heating material is encapsulated is, in a preferred embodiment, in the form of a sheet. The sheet can be composed of a single polymer or multiple different polymers (e.g., laminated layers of different polymers). The method by which the heating material is encapsulated within the polymer(s) is not critical. The heating element can also have other components or layers, such as an internal or exterior heat conducting layer (e.g., an externally-applied metal foil) or an internal or exterior insulating layer.

A plurality of the polymer-encapsulated heating elements can be fixedly attached to one another. Preferably, the heating elements are sheet-shaped and attached in an overlapping manner. However, the heating materials of the attached elements should not occur in an overlapping portion of the sheets (i.e., the sheets should be attached to one another in a way that the heating materials do not overlap).

A plurality of the heating elements can also be electrically connected to one another, so that they can be activated, de-activated, or modulated in conjunction with one another. The heating elements can electrically connected in series, in parallel, or in some combination thereof.

In one embodiment of the methods described herein, independently activatable heating elements are disposed near different seats in the passenger compartment of an aircraft. The heating elements are controlled by thermostats operable by individuals sitting in the corresponding seats, so that temperature preferences of the individuals can be satisfied.

The invention also relates to an aircraft compartment heater per se. The heater comprises an electrical resistance heating material encapsulated in a substantially non-compressible polymer. The polymer is substantially in the form of a sheet, and the heating material is disposed in a serpentine path within the sheet. The heater can be adapted for attachment to an aircraft (e.g., by sizing or shaping the sheet or by providing attachment points such as holes or hook-and-loop-type fastening fabric on the sheet.

The present invention represents an improvement in an aircraft having an internal compartment for which temperature control is desired. The improvement comprises disposing a heating element described herein within the compartment. Activation of the heater can be controlled by a thermostat disposed within the compartment. A plurality of heaters can be disposed within the compartment, and two or more of those heaters can be independently activatable. For example, the independently activatable heaters can be disposed near different passenger seats in the compartment and controlled by thermostats operable by individuals sitting in the corresponding seats.

This invention also represents an improvement in an aircraft having a pair of walls defining a space between them, wherein one of the walls is in thermal contact with an interior compartment of the aircraft. The improvement comprises mounting a heating element described herein in the space. The electrical resistance heating material of the heater is electrically connected with a voltage source and prevents, slows, or inhibits loss of heat from the interior compartment (e.g., to maintain the temperature of the compartment or to prevent it from falling below a minimum temperature) by providing heat to the compartment in an amount similar to the amount of heat known, believed, or anticipated to be lost from the compartment.

### BRIEF SUMMARY OF THE SEVERAL VIEWS OF THE DRAWINGS

The present invention is further described with reference to the following drawings.

FIG. 1 is a top plan cutaway view of an aircraft compartment heater described herein.

FIG. 2 is a top plan cutaway view of an alternative aircraft compartment heater described herein, illustrating a curved cut-out region.

### DETAILED DESCRIPTION OF THE INVENTION

The invention relates to apparatus and methods for heating a compartment within an aircraft. Prior art aircraft heating systems extract heat from a propulsion exhaust stream or from a centralized heating or combustion unit. In contrast, the heaters disclosed herein can be disposed at one or more locations within an aircraft compartment in order to provide localized heating of the compartment. The heater comprises a electrical resistance heating material encapsulated within a polymer body. The polymer body can be shaped to fit or conform to a particular location within an aircraft compartment. Alternatively, the body can be manufactured such that it can be bent, flexed, or trimmed to fit any of a variety of spaces within an aircraft compartment.

Definitions

As used in this disclosure, the following terms have the meanings associated with them in this section.

An “aircraft” means an apparatus capable of controlled atmospheric flight. Examples of aircraft include airplanes, gliders, helicopters, hot air balloons, dirigibles, rockets, and missiles.

An aircraft “compartment” means a space within the aircraft that is substantially isolated from the atmosphere surrounding the aircraft. Examples of aircraft compartments include passenger and crew compartments, cargo holds, weapon and avionics bays, and wheel wells.

An item is “polymer-encapsulated” if no portion of the item extends beyond one or more polymers surrounding it.

Two sheets of material are “laminated” if the sheets are bonded or connected along a substantial portion of a face of at least one of the sheets.

A “substantially non-compressible polymer is a polymeric material which, when made in the form of a sheet having a thickness of about 0.2 inch compresses less than 50% (preferably less than 40%, 30%, 20%, or 10%) when a force of 300 (preferably 400, 500, 750, 1000, or 1250) pounds is applied to a square portion of the sheet measuring 0.25 inch by 0.25 inch.

A “temperature switch” is an electrical switching component which either forms a conductive path or interrupts a conductive path at a characteristic temperature or within a characteristic temperature range.

A conductor is “fusible” if the conductor melts or is severed at a characteristic temperature or within a characteristic temperature range.

A first material is “staked” to a second material if the first material extends through a hole in the second material and either deformed or fused with the second material (e.g., at at least one point or in a ring using, for example, ultrasonic, heat-based, or other welding methods) in such a way that the deformed first material can no longer return through the hole in the second material without being broken or further deformed.

An electrical resistance heating element is “activated” by passing electric current through (i.e., applying a voltage across) the electrical resistance heating material therein, whereby heat is generated.

A “serpentine” path is a path having at least two curves therein. A serpentine path increases the length of the path in a given area, relative to a less curved path.

The “airframe” of an aircraft means the structural parts of the aircraft that give the aircraft its shape. For example, the airframe of an airplane includes the spars, struts, stringers, frames, beams, and skin of the airplane. The airframe does not include the power plant of the aircraft or passenger or crew accommodations such as seats and carpeting.

“Avionics” means electronic devices that are carried by an aircraft in flight.

### DETAILED DESCRIPTION

The invention relates to methods and devices for heating aircraft compartments. This purpose can be achieved using a heater that has an electrical resistance heating material encapsulated in a polymer. This heater unit is referred to herein as a polymer-encapsulated heating element. When the temperature of an aircraft compartment is lower than desired (e.g., below a desired minimum temperature), the temperature of the air in the compartment can be increased by activating the polymer-encapsulated heating element within the compartment. The heating element can be de-activated once the temperature of the compartment reaches a desirable value. In this way, the temperature within the compartment can be controlled.

The amount of heat produced by an electrical resistance heating material is influenced in known ways by the amount of voltage that is applied across the material (power equals the square of voltage divided by the resistance of the element) and the length of time for which the voltage is applied (energy—dissipated primarily as heat—equals power times the duration of operation). Thus, the approximate amount of heat generated by an electrical resistance heating element can be controlled by modulating the magnitude of electric voltage supplied to the element, the duration of the voltage supply, or both. This heat can be used to maintain the temperature of an aircraft compartment within a desired range.

Polymer-encapsulated electrical resistance heating elements are known to be useful, for example for heating fluids, as described in U.S. Pat. No. 5,586,214. For reasons disclosed herein, known floor-mounted foot warming elements made from elastomeric materials such as rubber and silicone are not suitable for the purposes described herein.

Electrical Resistance Heating Material

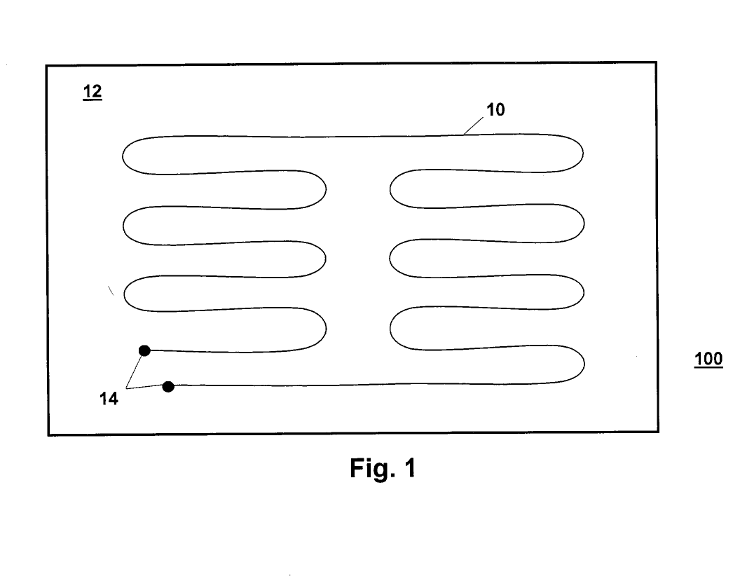

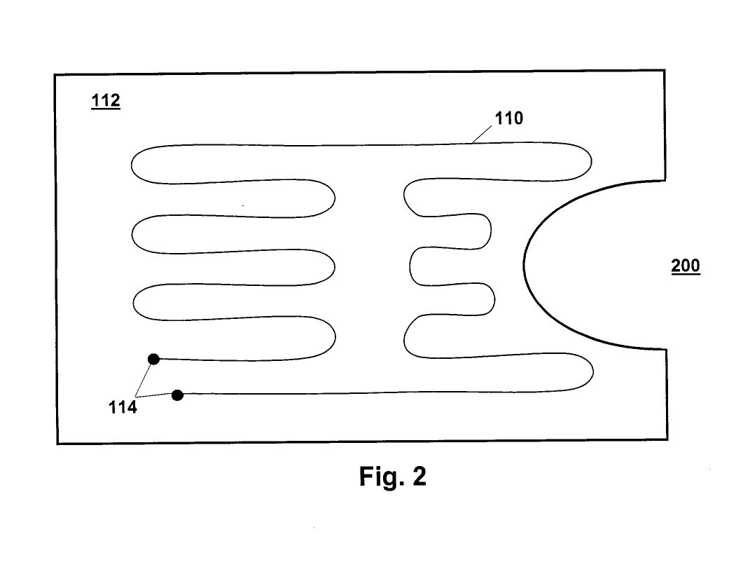

The electrical resistance heating material 10 and 110 is a substance which generates heat when electric current passes through it (i.e., when a voltage is applied across the material). Such substances are usually inefficient conductors of electricity, since generation of heat is usually the result of high impedance. The electrical resistance heating material 10 and 110 can be fashioned into multiple (e.g. 2-1000) windings, circuit paths, or traces (e.g., ca. 14 paths in FIGS. 1 and 2). Such multiple paths increase the amount of heat generated from the heating material per unit area of the heating element (relative to a heating element having a single, substantially linear heating material therein). When the heating element is in the form of a sheet, the heating material 10 and 110 is preferably laid out substantially in one plane parallel to the plane of the sheet, as shown in FIGS. 1 and 2.

FIG. 1 is a view through the interior of a rectangular, sheet-shaped polymer-encapsulated heating element 100 described herein. In this figure, an electrical resistance heating material 10 is disposed in a serpentine path within a polymer 12. Terminals 14 at either end of the electrical resistance heating material 10 extend through at least one face of the polymer 12.

FIG. 2 is a view through the interior of a irregular, sheet-shaped polymer-encapsulated heating element 200 described herein. In this figure, an electrical resistance heating material 10 is disposed in a serpentine path within a polymer 12. Terminals 14 at either end of the electrical resistance heating material 10 extend through at least one face of the polymer 12.

The form of the electrical resistance heating material is not critical. It can, for example, take the form of a wire, mesh, ribbon, foil, tape, film, lithographically- or electrically-deposited layer, a layer of any of a number of powdered conducting (or semi-conducting) metals, polymers, graphite, or carbon, or a conductive coating or ink. Conductive inks can be deposited, for example, using an ink jet printer. If a wire or ribbon is used, it preferably contains a Ni—Cr alloy, although certain copper, steel, and stainless-steel alloys are also suitable. The resistance heating wire can be provided in separate parallel paths, or in separate layers to provide multiple wattage ratings, such as printed circuit board layers. Whatever material is selected, it should be electrically conductive, and heat resistant. Numerous materials suitable for use as electrical resistance heating materials are known, and are generally referred to in the art as resistance wire or heating alloys. The electrical resistance heating material 10 or 110 can be fixed, sewn, or laid upon a supporting matrix (e.g., a mesh of fiberglass fibers) prior to or during encapsulation thereof by the polymer.

Encapsulating Polymer(s)

For use in aircraft compartments, the electrical resistance heating material 10 and 110 is desirably encapsulated in one or more polymers. The identity of the polymer(s) in which the heating material can be encapsulated is not critical. Substantially any polymer that will not melt upon heating of the heating material can be used. Preferred polymer materials are those which are not appreciably compressible under the loads to which they will normally be exposed. For this reason, polymers that exhibit elastomeric properties at their normal use temperatures are undesirable. For example, when the heating elements 100 and 200 are to be used under a carpet in the passenger cabin of an aircraft, the polymer should be sufficiently resistant to compression that it does not substantially compress under normal foot traffic (e.g., it preferably does not compress, or at least compresses less than 50% of its thickness when subjected to a force of three hundred pounds applied over a 1/4 inch square area). Further by way of example, heating elements 100 or 200 that are to be used to line the walls of a cargo bay should be able to withstand normal impacts expected from loading, unloading, and shifting of cargo in the bay.

Compression resistance of the polymer protects the electrical resistance heating material 10 or 110 from impacts that would sever all or part of the electrical circuit of which the material is part. Compression resistance also preserves the insulative properties of the polymer such that the heating material does not create an electrical short with nearby electrically conductive components. It is also preferable that the polymer 12 or 112 is substantially inelastic, so that impacts that result in potentially damaging compression of the polymer remain apparent after the impact, so that the potential damage can be assessed and the need to repair or replace the heating element 100 or 200 can be judged. In one embodiment, the polymer is sufficiently non-compressible that it compresses less than 50% of it's thickness when subjected to a force of three hundred pounds applied over a 1/4 inch square area. In another embodiment, the polymer is sufficiently non-compressible that it compresses less than 50% of it's thickness when subjected to a force of five hundred pounds applied over a 1/4 inch square area. In another embodiment, the polymer is sufficiently non-compressible that it compresses less than 20% of it's thickness when subjected to a force of five hundred pounds applied over a 1/4 inch square area. In yet another embodiment, the polymer is sufficiently non-compressible that it compresses less than 50% of it's thickness when subjected to a force of one thousand pounds applied over a 1/4 inch square area. In yet another embodiment, the polymer is sufficiently non-compressible that it compresses less than 20% of it's thickness when subjected to a force of one thousand pounds applied over a 1/4 inch square area. Use of a compression- and impact-resistant polymer allows a thinner, and therefore lighter, heater than would be possible with an elastomeric or rubbery material, thereby reducing weight and yielding improved fuel efficiency for the aircraft.

Other criteria important for polymer selection are flammability and toxicity. In the environment of an aircraft in flight (or on the ground), access to fire-fighting materials and personnel can be severely limited, and passengers and crew members may not be able to escape. For these and other reasons, the polymer 12 or 112 selected for encapsulating the heating material 10 or 110 should be selected to be substantially non-flammable, both at the anticipated temperature of the compartment in which the heating element 100 or 200 will be used and at the temperature that the heating material is anticipated to attain upon application of voltage thereto. In the event the polymer is induced to burn (e.g., by a fire occurring outside the heating element), the smoke, fumes, particles, and other materials released from the heating element preferably exhibit relatively low toxicity. This can be achieved by selecting materials (including polymers) which are known not to produce highly toxic materials upon combustion.

Examples of suitable polymers include thermoplastic materials such as fluorocarbons, polypropylene, polycarbonate, polyetherimide, polyether sulphone, polyarylsulphones, and polyetheretherkeytones, polyphenylene sulfides, and mixtures and co-polymers of these thermoplastics. This list of examples is not exhaustive. Substantially any polymer that exhibits low compressibility, resistance to melting, and high electrical resistance at its anticipated operating temperature can be used.

In one embodiment, at least one portion of the heating element 100 and 200 is made from a polymer 12 or 112 having a relatively high thermal conductivity, so that heat generated by passing current through the electrical resistance heating material will flow from the heating material to the exterior of the heating element. In one embodiment, the heating element is sheet-shaped, and one face of the sheet is formed from a polymer having a significantly (e.g., 2-fold, 5-fold, or higher) greater thermal conductivity than the polymer from which the opposite face of the sheet is formed. In this embodiment, a greater proportion of the heat generated by the heating material flows through the first face (i.e., the face with the higher thermal conductivity) than through the other face. Such an embodiment can be made, for example, by laminating two polymer sheets together with the heating material interposed between them. This can be achieved, for example, by printing or placing the heating material on one polymer sheet and thereafter laying the other polymer sheet across the first and bonding the two polymer sheets under pressure, in an evacuated vessel, or both.

The polymer 12 or 112 used to encapsulate the heating material can contain up to about 40% (preferably 5% to 40%, by weight) fiber reinforcement, such as graphite, glass, ceramic, or polyamide fiber. These polymers can be mixed with various additives for improving thermal conductivity and mold-release properties. Thermally conducting, preferably substantially non-electrically conducting, additives can be used in amounts of about 5-80 wt %. Desirable thermally-conducting additives include ceramic powder such as Al₂O₃, MgO, ZrO₂, boron nitride, silicon nitride, Y₂O₃, SiC, SiO₂, TiO₂, and the like.

Rigid polymeric panels can exhibit better endurance properties in certain working environments (e.g., when minor impacts are routine). For this reason, relatively rigid polymer-encapsulated heating elements are desirable for some uses (e.g., to line aircraft cargo bays in which contact between the walls of the bay and cargo or cargo handlers is not unusual). As with polymer softening agents and methods, compositions and methods for enhancing the rigidity of various polymers are known in the art. Selection of a polymer rigidity-enhancing agent or process is merely a routine design choice. When a polymer-encapsulated heating element described herein is made relatively rigid, it is preferably formed in substantially the same shape as that in which it will ultimately be activated.

A variety of other additives are available for polymers to tune specific properties, such as water resistance, heat resistance, impact strength, and the like. The selection of these additives is a routine design choice, driven by the needs of the particular requirements for the heater panel so long as its ability to insulate the electrical resistance heating material is retained.

Additional protection of polymer-encapsulated heating elements 100 and 200 described herein can be achieved by adding reinforcing materials (e.g., fiberglass fibers) to the polymer 12 or 112 which encapsulates the electrical resistance heating material 10 and 110 or by coupling the heating element with a protective layer, such as a thin metal plate or layer.

Conductors

Many polymers are relatively poor heat conductors. For this reason, “hot spots”—areas of localized heating—can occur on a polymer-encapsulated heating element disclosed herein. In many applications, relatively uniform heating of the heating element is desirable. Uniformity of element heating can be enhanced by associating the heating element with a relatively good heat conductor, such as metal strips, screens, or plates or ceramic fibers or plates. The heat conductor can be embedded within the polymer, applied to the surface of the polymer, or both. If the heat conductor is a poor electrical conductor, the electrical resistance heating material can be pressed or adhered against the heat conductor or embedded within it prior to encapsulating the heating material with the polymer.

In one embodiment, a sheet-shaped polymer-encapsulated heating element has five elements. In this example, the element comprises two sheets of a relatively heat-conductive polymer and one sheet of a relatively heat-non-conductive polymer (i.e., the two sheets of polymer each exhibit a greater thermal conductivity than the one sheet). The electrical resistance heating material 10 and 110 is sandwiched between the two relatively heat-conductive polymer sheets. A metal (e.g., aluminum) film is sandwiched between one of the two sheets and the relatively heat-non-conductive polymer sheet. The metal film covers most of the area of the heating element (and optionally extends to the edges of the polymer sheets). Heat from the activated electrical resistance heating material flows through the relatively heat-conductive polymer sheets to either the exterior of the heating element or to the metal film. Heat that reaches the metal film spreads across the area of the film and thence into one of the adjacent polymer layers (and out the sides of the heating element if the metal film extends to the edge thereof). Because one of the two adjacent polymer layers has a higher thermal conductivity than the other, a greater proportion of the heat should pass to and through that layer. The heat generated by this heating element will be more uniformly spread across the surface of the heating element than it would be across the surface of an otherwise identical element that lacked the metal film layer. A second embodiment is identical to the one described in this paragraph, except that the positions of the heating material and the metal film are reversed.

Insulation

When it is preferable that the polymer-encapsulated heating element 100 and 200 generate heat preferentially at one portion of the element than at another, one or more insulating materials can be interposed between the electrical resistance heating material and the areas at which heat generation is not preferred. The insulating material can be embedded with the polymer 12 or 112 (e.g., as a sheet in a laminated sheet-shaped heating element), applied to the exterior of the heating element, or both. The identity of the insulating material is not critical, so long as the insulating material can withstand the normal operating temperature of the heating element. Examples of insulating materials include asbestos fibers and cloths, glass fibers and cloths, spun cotton, wool, felt, or other textiles, polymer foams, and insulating ceramic materials. Selection of an appropriate insulating material is a routine design choice, taking into account the normal operating temperature of the heating element, any need for flexibility of the heating element, the cost of the insulating material, and other routine design factors. Any insulation should also be selected to have relatively low flammability and low toxicity in the event that it is caused to burn.

Electrical Connectors

Because the electrical resistance heating material 10 and 110 of the heating element is operated by flow of electric current, means for providing the current to the heating material are necessary. Although the heating material 10 and 110 could extend beyond the encapsulating polymer 12 or 112 so that electrical connection could be made therewith, this arrangement results in an exposed portion of heating material. In light of the high temperature exhibited by many electrical resistance heating materials, this arrangement can therefore be undesirable. In the environment of an aircraft in flight, exposed high temperature materials can cause fire or damage to other aircraft components, and these occurrences might be difficult to detect or remedy. A preferable arrangement is for the electrical resistance heating material to be completely encapsulated in the polymer(s) of the heating element, so that no portion of the heating material contacts the environment surrounding the heating element.

Complete encapsulation of the heating material can be achieved by connecting the heating material with an electrical conductor at a junction that is isolated from the exterior of the heating element by one or more polymer layers. By way of example, a wire can be brazed, soldered, welded, clamped, or otherwise securely contacted with ends of the heating material. The heating material, the junction between the heating material and the electrical conductor, and optionally a portion of the electrical conductor can be embedded with a polymer or laminated between polymer sheets.

The identity of the electrical conductor is not critical. It can be substantially any electricity-conducting material, although conductors with relatively low heat conductance can be preferable. Examples of suitable electrical conductors include metallic terminals 14 and 114 (e.g., button or stud-post terminals), wires, and the like. The electrical conductor is preferably adapted to facilitate connection with an aircraft electrical system. By way of example, the electrical conductor can be a pair of wires (i.e., one attached to each end of the heating material) that are embedded in the polymer at their proximal ends and that have stripped distal ends. As another example, the electrical conductor can be a pair of threaded terminal posts for receiving a ring- or flared spade-type electrical connector for connecting the terminal to an aircraft electrical system. In this example, the heating element can be supplied with screw-on fasteners for securing an electrical connector to the terminal post.

A pair of metal terminal studs can be brazed to the ends of a nickel-chromium alloy heating material, and the junctions between the studs and the material are encapsulated with the polymer 12 or 112 of the heating element 100 or 200. Individual wires are welded to each of the two terminals. The portion of the terminal extending beyond the polymer of the heating element and the proximal ends of the wires (i.e., the ends welded to the terminals) are covered in a non-conducting material, such as the same or a different polymer. Alternatively, the heating material can be joined with terminal studs or with the wires by crimping the heating material, the wires, or both, within any of a variety of known crimpable electrical connectors. Furthermore, multiple heating materials can be connected within the polymer using such elements (i.e., by connecting the materials prior to polymer encapsulation). The distal ends of the wires are stripped to facilitate easy connection to an aircraft electrical system. It is preferable that there be no exposed conductive surface other than the portion of the heating element that is used to electrically connect the element with an aircraft's electrical system. This reduces the possibility of short-circuiting, electrical arcing, and ignition.

A plurality of the heating elements 100 and 200 described herein can be installed in the same aircraft, either in the same compartment or in different compartments. Multiple heating elements can be electrically connected in series, in parallel, or in some combination thereof.

An electrical controller can be installed between the polymer-encapsulated heating element(s) 100 and 200 installed in an aircraft compartment and a voltage source to which the element(s) are connected. By limiting voltage applied across the electrical resistance heating materials of the elements, the controller modulates the amount of heat generated by the heating elements.

The way in which the electrical controller operates is not critical. It can, for instance, modulate voltage (and therefore current) in response to the temperature within the aircraft compartment in which the controlled heating element(s) are installed. Alternatively, the controller can operate on a simple timing mechanism (i.e., alternating one-minute voltage application and disconnect periods). However, owing to the danger of overheating on an aircraft, the electrical circuit of which the heating element(s) are part preferably contains some temperature controller that is able to decrease or interrupt voltage if a maximum temperature is reached in the compartment in which the heating element(s) are located. The temperature controller can, for example, be a thermostat (e.g., a simple set temperature on/off thermostat), a thermistor, a fusible link, a bimetallic switch, or the like. In one embodiment, each heating element has a temperature controller (e.g., a fusible link or bimetallic switch) associated therewith, such that voltage applied to the heating element is interrupted if the temperature of the heating element exceeds a selected value.

In one embodiment, multiple temperature sensors (e.g., thermocouples) are located at different locations within the same compartment. The sensors can be connected to a single electrical controller that modulates voltage for all of the heating elements in the compartment. Alternatively, the sensors can be connected with one or more electrical controllers, whereby voltage is controlled for individual heating elements or groups of heating elements located in different parts of the compartment. In this way, heating elements in different parts of the same compartment can be activated independently to modulate the temperature in the different parts of the compartment. By way of example, if the temperature at the back of a cargo compartment is lower than the temperature at the front of the compartment, the heating elements installed in the rear of the cargo compartment can be activated (or activated for a longer period or at a higher voltage than those in the front) to more nearly equalize the temperatures in the front and back of the compartment. As another example, heating elements located in close proximity to various passenger seats can be activated to raise the temperature to a level set for all seats in the passenger compartment or to temperature levels desired by passengers using thermostats associated with individual seats or groups of seats.

If a greater amount of heat is desired in a certain location to provide a higher temperature environment or compensate for a greater heat loss, an alternative to a temperature controller is to increase the amount of heat generated by the electrical resistance heating material in that location as compared with the surrounding region. This can be done by decreasing the spacing of the circuit path described by the electrical resistance heating material, or by reducing the resistance per unit length of the material in that location. This will cause the heater to dissipate additional power, generating more heat in the desired area. Likewise, reduced heat can be generated by increasing the circuit path spacing or increasing the resistance per unit length of the electrical resistance element material.

Manufacture

Methods of encapsulating electrical resistance heating elements in one or more polymers are known in the art, and the particular method used to achieve the encapsulation is not critical. Examples of suitable methods are described in U.S. Pat. No. 5,521,357, U.S. Pat. No. 5,586,215, and U.S. Pat. No. 6,415,501. Basically, an electrical resistance heating material 10 and 110 is formed into a circuit path. The heating material 10 and 110 can be free-standing (e.g., a length of resistance wire bent into a serpentine path), supported (e.g., a length of resistance wire unable to retain its shape under the influence of gravity, stitched to a non-woven fiberglass mat), or formed on a substrate (e.g., a conductive film formed on a polymeric sheet). Some type of electrical conductors 14 and 114 (terminals, wires, etc.) are connected to the ends of the heating material. The entire length of the heating material 10 and 110 is encased in one or more polymers 12 and 112 (except for the portion where the electrical connectors meet the heating material). The polymer 12 or 112 can be molded about the heating material (e.g., by suspending the heating material in an injection mold that is subsequently filled with a thermosetting polymer resin. Alternatively, the heating material 10 and 110 can be sandwiched between polymer sheets that are laminated (e.g., fused, adhered, staked, stapled, etc.) together and/or laminated, glued, removably attached (e.g., using a hook-and-loop-type fabric or other fastener), or otherwise fixed to an aircraft floor or wall panel. The resulting heating element 100 or 200 can be connected to an aircraft electrical supply by way of the electrical conductors.

A specific example of a method of manufacturing a polymer-encapsulated heating element is set forth in Example 1.

Use of Polymer-Encapsulated Heating Elements in Aircraft Compartments

Polymer-encapsulated heating elements can be advantageous for use in aircraft compartments for a variety of reasons. For instance, if the electrical resistance heating material 10 and 110 is contained within a polymer 12 or 112, then the likelihood is decreased that a fire could be caused by contact between the activated electrical resistance heating material and a flammable material in the compartment. Flammability and explosion hazards attributable to flammable or explosive vapors can also be decreased in the absence of an exposed electrical resistance heating material surface. Unlike heating systems that use power plant compressor bleed air as a heat source, polymer-encapsulated electrical resistance heating elements do not decrease the thrust or fuel efficiency of turbofan or other jet engines.

Another significant advantage of polymer-encapsulated heating elements 100 and 200 is that they can be placed at multiple locations in an aircraft compartment and operated independently. In this way, the temperature of regions of an aircraft compartment that are not well controlled by existing heating systems (e.g., ‘cold’ regions of a passenger compartment having an air heating and recirculation system) can be increased by installation of the heating elements in those regions. The temperature of different regions of the compartment can thereby by manipulated, either by the crew of the aircraft or by its passengers.

In one embodiment, one or more polymer-encapsulated heating elements 100 and 200 described herein are installed in an aircraft in sufficiently close proximity to a passenger or crew seat that heat generated by the heating element warms a person in the seat (i.e., either directly or by warming air in the vicinity of the seat). Activation of the heating element 100 or 200 can be modulated by a controller (e.g., a thermostat) that is operable by a person in the seat. For example, a thermostat controlling activation of one or more of the heating elements can be located on the seat (e.g., on an armrest) or at a location (e.g., on a cabin wall) near the seat. Suitable locations for heating elements used for this purpose include i) within the seat, ii) beneath the leg space of the seat, iii) in a wall or ceiling of the compartment adjacent the seat, and iv) on a surface (e.g., on a retractable airline seat-back tray table) in front of the seat. Of course, heating elements 100 and 200 can be installed in close proximity to multiple seats on an aircraft (e.g., in close proximity to all passenger seats), and the heating elements corresponding to a seat can be operable by the seat occupant. Alternatively, heating elements 100 and 200 corresponding to a plurality of seats (e.g., all of the seats in a selected row or section of an aircraft) can be jointly operable by a single controller.

In another embodiment, one or more of the polymer-encapsulated heating elements 100 and 200 described herein are used to heat a compartment of an aircraft that contains cargo or baggage, but that does not contain people. In this embodiment, activation of the heating element within the compartment heats the air within the compartment. Maintenance of a minimum temperature or periodic heating can be important for preventing cold-related damage to cargo or items contained in baggage.

One way to achieve this purpose is to line all or a substantial portion of the wall of the compartment defined by an exterior surface of the aircraft with sheet-shaped polymer-encapsulated heating elements described herein. The sheets can be attached to the ribs of the aircraft fuselage, for example. Installed in this way, the sheets can serve both as an insulator (i.e., isolating compartment air from the cold exterior surface of the aircraft in flight) and as a heater (i.e., adding heat to the air in the compartment). Addition of an insulating material to the exterior (i.e., non-compartment side) of the sheets can reduce heat loss to the exterior of the aircraft, decreasing the energy needed to maintain compartment temperature. Incorporation of an insulating material (e.g., by forming the exterior face of the sheet using a polymer having a relatively low thermal conductivity, relative to the polymer used to form the internal face of the sheet) into the sheet can have the same effect.

When the surface covered with heating element sheets installed in this manner is relatively large, this method has the added advantage that the heating elements can be operated at relatively low power and low temperature, thereby decreasing the danger of fire caused by heat build-up between a heating element and an item in the compartment. Nonetheless, mounting the heating element sheets in a way in which contact between the sheet and an item in the compartment is minimized or avoided can be preferable.

The heating element(s) 100 and 200 that are installed in an aircraft compartment can be operated to substantially offset predicted, measured, perceived, or anticipated heat loss from the compartment. Thus, although the heating elements will not necessarily warm the compartment (i.e., they will not necessarily effect a temperature increase within the compartment), they can slow, limit, or prevent cooling of the compartment. In this way, the temperature within the compartment can be maintained, permitted to drop relatively slowly, or kept above a minimum value.

In still another embodiment, a polymer-encapsulated heating element 100 or 200 as described herein can be used to warm or maintain the temperature of an avionics compartment. It is known that various electronic devices function best within a range of temperatures (the particular temperatures depending on the device). When the temperature of an environment in which an aircraft operates is expected to fall outside this range, at least at times, an electronic device can malfunction or fail. These temperature effects can limit the equipment that can be used in an aircraft's anticipated environment. Furthermore, unanticipatedly cold conditions can interfere with operation of an aircraft's electronics, potentially endangering flight safety. By including a polymer-encapsulated heating element described herein in an avionics compartment of an aircraft, the temperature of the compartment can be maintained within a range amenable to proper operation of the instrument(s) in the compartment.

In yet another embodiment, a polymer-encapsulated heating element as described herein can be used to warm or maintain the temperature of a compartment containing temperature-sensitive mechanical equipment (e.g., aircraft landing gear or a weapon system). Of course, maintenance of temperature with the compartment can be effected to protect both electronic and mechanical (including hydraulic) systems.

Unlike prior art component heaters, the polymer-encapsulated heating elements 100 and 200 described herein need not contact temperature-sensitive mechanical devices or electronic components. This is because the heating elements 100 and 200 described herein can maintain an adequate temperature within the compartment containing the device or component, rather than transferring heat to the device or component by conduction. This can be advantageous for avoiding heat damage to sensitive electronic components and for simplifying the construction and operation of a mechanical device (i.e., because the device need not have the heating element bolted, strapped, or glued thereto or wrapped around it).

Polymer-encapsulated heating elements 100 and 200 can be included in newly constructed aircraft during the assembly process. Alternatively, such heating elements can be added to existing aircraft. The heating elements can also be added to an aircraft as a readily-removable component, so that the heating elements can be removed when the aircraft is to be used in an environment in which compartmental heating is not desired.

The shape of the heating element 100 or 200 attached to an aircraft is not critical. For ease of manufacture, flat shapes can be preferred, such as a generally rectangular sheet of polymer encapsulating an electrical resistance heating material, as shown in FIG. 1. Of course, other shapes (e.g., round, oval, triangular, trapezoidal, or irregular) can also be used. Desirable shapes for any particular aircraft are recognized by artisans who wish to add the heating elements to aircraft compartments, at least in view of this disclosure. The shape of a heating element 100 or 200 can be adapted to fit a particular location on an aircraft, as exemplified in FIG. 2.

Individual heating elements, or sets of heating elements, adapted to fit within in a compartment of a selected aircraft (e.g., the forward cargo compartment a Boeing 747-400 jet) can be sold in standardized sizes. By way of example, an individual heating element having a shape adapted to the shape of the starboard side wall of the Boeing 747-400 forward cargo hold can be made, and can include holes or other adaptations for attaching the heating element to ribs on the wall of the hold. Alternatively (and preferably, for so large an area), a set of heating elements can be made, wherein the set comprises multiple heating elements. Each of the heating elements can be adapted to fit on a particular part of the starboard side wall of the Boeing 747-400 forward cargo hold and can have holes or other adaptations for securing the individual heating elements to its corresponding part of the wall, such that when all of the parts of the kits are installed, all or substantially all of the wall is covered by heating units.

Similarly, sets of identical heating units (e.g., rectangular heating elements which fill the space between many, but not all, of the ribs or spars in an aircraft compartment) can be made. Those identical heating units can be installed at locations in the compartment at which the units fit, and remaining spaces can remain without heating units.

In another embodiment, the heating elements 100 and 200 described herein are sold as a kit adapted for modification of a portion of an aircraft compartment, wherein the portion is located in close proximity to a crew or passenger seat. By way of example, such a kit can include i) a panel-shaped polymer-encapsulated heating element adapted to fit on the back of a standard first class seat of a Boeing 747-400 aircraft, ii) another panel-shaped polymer-encapsulated heating element adapted to fit beneath the leg space of the same seat, and iii) one or more other panel-shaped polymer-encapsulated heating elements, each adapted to fit on a cabin wall or ceiling located in close proximity to the same seat. The kit can also include an electrical voltage-controlling element (e.g., a thermostat) which can be electrically connected in a circuit with the heating elements of the kit and a source of electrical potential (i.e., voltage) and which can be mounted in sufficiently close proximity to the seat that it can be operated by the seat occupant.

The means by which the heating element 100 or 200 is attached to an aircraft is not critical. When the heating element is designed for use in a known location in a particular aircraft, then the heating element can be adapted for mounting to connectors or structural elements (e.g., mounting tracks or threaded holes) that are present at that location. When the precise location or the identity of the aircraft in which the heating element is to be used is not known, the heating element can have mounting elements (e.g., holes, half of a hook-and-loop type fabric fastener, snaps, or buttons) located at standard distances (e.g., every two or four inches) along one or more edges of the heating element. The heating elements can be mounted rigidly to a portion of the aircraft, for example by screwing or bolting the heating elements to the airframe. The heating elements can instead be resiliently mounted to a portion of the aircraft, for example using elastic lashing or an elastic cement.

Although a polymer-encapsulated heating element 100 or 200 described herein can be mounted substantially permanently to the aircraft (e.g., by bonding the heating element to the interior of a fuselage panel), in certain embodiments the heating panels are removable. Removability of the heating panels facilitates replacement of any malfunctioning or damaged panels and reduction of aircraft weight when the heating panels are not needed. Examples of removable mountings for the heating elements described herein include screws, bolts, plastic straps, hook-and-loop type fabric fasteners, snaps, buttons, ties, and retaining rails.

Multiple polymer-encapsulated heating elements can be fastened to one another to form a heating element assembly prior to attaching the assembly to an aircraft. The means by which individual heating elements are attached to one another is not critical. By way of example, the heating elements can be in the form of sheets, and the sheets can be glued, clamped, staked, stapled, bolted, or welded together. In this way, heating element assemblies adapted to fit irregular spaces in an aircraft compartment (e.g., a portion of a compartment wall adjacent a window, a door, or both or part of the floor of a passenger cabin) can be made by attaching heating elements having basic geometric shapes (e.g., squares, rectangles, and triangles) to one another. Manufacture of basic geometric shapes can be simpler than manufacture of more irregular shapes because irregular molds and extensive post-molding trimming is not required. The method used to attach the individual heating elements preferably does not affect the resistance of the heating material 10 or 110 or the dielectric strength of the polymer 12 or 112.

The polymer-encapsulated heating elements 100 and 200 preferably have a portion that does not contain the electrical resistance heating material therein. By way of example, a rectangular heating element in the form of a sheet can have dimensions of about 8 inches in length and 12 inches in width (ignoring the depth), wherein the electrical resistance heating material is no closer than one inch to any of the four sides of the 8×12 inch rectangular area (i.e., the electrical resistance heating material is present only in a 6×10 inch area of the sheet). The one-inch border can be punctured, staked, glued, clamped, cut, or otherwise manipulated without damaging the electrical resistance heating material.

As an example, another way in which the polymer-encapsulated heating elements 100 and 200 described herein can be used is as follows. Aircraft frequently have dual walls having a space therebetween (e.g., a space between an exterior fuselage panel of the aircraft and the surface of a passenger compartment therein). A polymer-encapsulated heating element 100 or 200 can be disposed within this space and activated to heat the space and prevent cooling of the internal wall by maintaining the temperature of the inter-wall space. As a result, less insulation need be used to prevent cooling of the inner wall, and fuel efficiency of the aircraft can be increased. The temperature of the space can be maintained at substantially any desired temperature during flight (e.g., greater than 32, 40, 50, 60, or 70 degrees Fahrenheit).

### EXAMPLES

The invention is now described with reference to the following Examples. These Examples are provided for the purpose of illustration only, and the invention is not limited to these Examples, but rather encompasses all variations which are evident as a result of the teaching provided herein.

### Example 1

Manufacture of a Polymer-Encapsulated Heating Element for an Aircraft Compartment

This Example describes how a sheet-shaped polymer-encapsulated heating element suitable for use in an aircraft compartment was made.

Resistance wires made from various alloys known for this purpose were spun together to form a stranded wire (electrical resistance heating material) having a desired resistance value required for the particular heater. The stranded wire comprised copper/Nickel resistance alloys including those known in the art as Alloy 180, Alloy 90, Alloy 60, and Alloy 30. The stranded wire was sewn onto a random non-woven fiberglass mat in a serpentine pattern having a size somewhat smaller than the total area of the final heating element. The fiberglass mat was trimmed to also be somewhat smaller than the total area of the final heating element.

A Teflon® sheet was draped across the bottom plate of a lamination mold. The mold was a flat aluminum plate with a slightly raised border that matched the size of the final heating element. A black polycarbonate sheet (Lexan® FR700-701, 0.020 inch thick) having the size and shape (e.g., a rectangle having dimensions of 34 inches by 23 inches) of the desired heating element was placed atop the Teflon® sheet. The fiberglass mat with the attached electrical resistance heating material was placed atop the polycarbonate sheet, and a second, identical sheet of polycarbonate was place on top of the fiberglass mat. A silicone rubber pad (about 1/8 inch thick) was place atop the layers, and this was topped with a thin (0.06 inch) aluminum plate. The assembled layers were provided to a lamination press.

The lamination press had been preheated to about 390-400 degrees Fahrenheit prior to providing the stacked sheets thereto. After providing the sheets to the press, the press was activated. The stacked sheets were compressed for two minutes at a pressure of 37.5 pounds per square inch (gauge), and then for 8 minutes at 210 pounds per square inch (gauge). After these compression steps, the lamination press was deactivated, and the laminated materials were left on the platen of the press for 10 minutes while the press cooled. The mold was removed, and the laminated heating element was withdrawn from the mold.

Multiple panels made as described in this example were fastened to one another by ultrasonic staking.

### Example 2

Load Testing of Polymer-Encapsulated Heating Element

A polymer-encapsulated heating element made as described in Example 1 was subjected to load testing. In this testing, a force of 500 pounds was applied using a 1/4 inch×1/4 inch steel pad to a heating element having a carpet and carpet pad thereon. This load was applied 10 times at evenly spaced locations across the face of the heating element, and then seven additional loads (increasing incrementally to 1245 pounds) were applied to evenly spaced locations across the face of the heating element.

The resistance of the electric circuit path in the heating element did not significantly increase following any load application step. These results indicate that the polymer-encapsulated heating element is able to endure load application that is no more than typical in some aircraft compartment environments. These results also indicate the suitability of using such heating elements in such compartments.

The disclosure of every patent, patent application, and publication cited herein is hereby incorporated herein by reference in its entirety.

While this invention has been disclosed with reference to specific embodiments, it is apparent that other embodiments and variations of this invention can be devised by others skilled in the art without departing from the true spirit and scope of the invention. The appended claims include all such embodiments and equivalent variations.

1. A method of controlling the temperature within an aircraft compartment, the method comprising activating a heating element in the compartment, wherein the heating element comprises an electrical resistance heating material encapsulated in a substantially non-compressible polymer.

2. The method of claim 1, wherein the heating element is activated when the temperature within the compartment is below a selected minimum temperature.

3. The method of claim 2, wherein the heating element is activated when the temperature within the compartment is not greater than a selected maximum temperature.

4. The method of claim 1, wherein the heating element is activated when the temperature within the compartment is not greater than a selected maximum temperature.

5. The method of claim 1, wherein the heating element is activated periodically while the aircraft is in flight.

6. The method of claim 1, wherein the heating material is connected with a voltage source by way of a pair of electrical terminals extending through the polymer.

7. The method of claim 6, wherein the electrical terminals are connected with voltage source by way of wires and the terminals are encapsulated within a second polymer.

8. The method of claim 1, wherein the heating material is connected with a voltage source by way of a pair of wires extending through the polymer.

9. The method of claim 1, wherein the electrical circuit that comprises the heating element further comprises a temperature sensing device.

10. The method of claim 9, wherein the temperature sensing device contacts the polymer.

11. The method of claim 10, wherein the temperature sensing device is fusible at a selected temperature.

12. The method of claim 10, wherein the temperature sensing device deactivates the heating element if the temperature of the polymer exceeds a selected temperature.

13. The method of claim 10, wherein the temperature sensing device deactivates the heating element if the temperature within the compartment exceeds a selected temperature.

14. The method of claim 9, wherein the temperature sensing device does not contact the polymer.

15. The method of claim 14, wherein the temperature sensing device deactivates the heating element if the temperature within the compartment exceeds a selected temperature.

16. The method of claim 14, wherein the temperature sensing device modulates the voltage applied to the heating element in response to the temperature within the compartment.

17. The method of claim 9, wherein the temperature sensing device modulates the duration of the voltage application to the heating element in response to the temperature within the compartment.

18. The method of claim 9, wherein the temperature sensing device is selected from the group consisting of a thermocouple, a temperature switch.

19. The method of claim 9, wherein the temperature sensing device is a temperature switch.

20. The method of claim 1, wherein the polymer is in the form of a sheet.

21. The method of claim 20, wherein two faces of the sheet are composed of different polymers.

22. The method of claim 21, wherein the polymer on one face of the sheet exhibits a significantly greater thermal conductivity than the polymer on the other face of the sheet.

23. The method of claim 20, wherein the heat-reflective material is attached to the sheet on one side of the heating material.

24. The method of claim 23, wherein the sheet of the heat-reflective material is laminated to the polymer sheet.

25. The method of claim 20, wherein a heat conductor is disposed in the polymer in the plane of the sheet.

26. The method of claim 25, wherein a sheet of the heat conductor is laminated to the polymer sheet.

27. The method of claim 20, wherein an insulating material is disposed against one face of the polymer sheet.

28. The method of claim 27, wherein a sheet of the insulating material is laminated to the polymer sheet.

29. The method of claim 20, wherein the heating material is interposed between two polycarbonate layers.

30. The method of claim 20, wherein a plurality of the polymer-encapsulated heating elements are fixedly attached to one another.

31. The method of claim 20, wherein the sheets are attached in an overlapping manner.

32. The method of claim 31, wherein the heating materials of the elements do not occur in overlapping portions of the sheets.

33. The method of claim 31, wherein the sheets are staked.

34. The method of claim 1, wherein a plurality of the heating elements are electrically connected.

35. The method of claim 34, wherein the heating elements are electrically connected in series.

36. The method of claim 34, wherein the heating elements are electrically connected in parallel.

37. The method of claim 1, wherein the compartment is selected from the group consisting of i) a passenger compartment, ii) a crew department, iii) a cargo compartment, and iv) an avionics compartment.

38. The method of claim 1, wherein a plurality of the polymer-encapsulated heating elements are disposed within the compartment and at least two of the heating elements are independently activatable.

39. The method of claim 38, wherein at least two of the independently activatable heating elements are controlled by thermostats disposed in different regions within the compartment.

40. The method of claim 38, wherein at least two of the independently activatable heating elements are disposed near different seats in the passenger compartment and are controlled by thermostats operable by individuals sitting in the corresponding seats.

41. The method of claim 40, wherein each of the independently activatable heaters is disposed in a location selected from the group consisting of i) within the corresponding seat, ii) beneath the leg space of the corresponding seat, iii) in a wall or ceiling of the compartment adjacent the corresponding seat, and iv) on a surface in front of the corresponding seat.

42. An aircraft compartment heater comprising an electrical resistance heating material encapsulated in a substantially non-compressible polymer, wherein the polymer is substantially in the form of a sheet, the heating material is disposed in a serpentine path within the sheet, and the heater is adapted for attachment to an aircraft.

43-52. (canceled)

53. An aircraft compartment heater system comprising two or more independently activated electrical resistance heaters connected in parallel in an electrical circuit having a voltage source, each heater of which comprises an electrical resistance heating element encapsulated in a substantially non-compressible polymer that is substantially in the form of a sheet, wherein the electrical circuit comprises two or more thermostats disposed in different regions within the aircraft compartment each of which independently modulates the voltage application to the two or more electrical resistance in response to the temperature sensed by each of the two or more thermostats.

54. The aircraft compartment heater system of claim 53, wherein at least two of the independently activatable heating elements are disposed near different seats in the passenger compartment and are controlled by thermostats operable by individuals sitting in the corresponding seats.

55. The aircraft compartment heater system of claim 54, wherein each of the independently activatable heaters is disposed in a location selected from the group consisting of i) within the corresponding seat, ii) beneath the leg space of the corresponding seat, iii) in a wall or ceiling of the compartment adjacent the corresponding seat, and iv) on a surface in front of the corresponding seat.

56. The aircraft compartment heater system of claim 55, wherein the thermometer is selected from the group consisting of a temperature responsive switch, and a thermistor.
